(19) United States
(12) Patent Application Publication
(10) Pub. No.: US 2026/0022780 A1
(43) Pub. Date: Jan. 22, 2026

(54) VALVE DRIVE AND PROCESS VALVE

(71) Applicant: GEMÜ Gebr. Müller Apparatebau GmbH & Co. Kommanditgesellschaft, Ingelfingen (DE)

(72) Inventors: Axel Wegert, Neuenstadt am Kocher (DE); Michael Baumgärtner, Dörzbach (DE); Holger Kühne, Veitshöchheim (DE)

(21) Appl. No.: 19/267,484

(22) Filed: Jul. 11, 2025

(30) Foreign Application Priority Data
Jul. 19, 2024 (DE) 10 2024 120 502.4

(51) Int. Cl. F16K 27/02; F16K 7/12; F16K 17/196

(52) U.S. Cl. CPC F16K 27/0236; F16K 7/126; F16K 17/196

(57) ABSTRACT

A valve drive for a process valve includes a drive housing having an opening that leads into an interior of the drive housing, and a closure configured to close the opening. In a locked state, at least one latching hook of the closure engages at least one cutout of the drive housing. To unlock the drive housing and the closure, the latching hook is moved out of the cutout by a relative rotational movement between the drive housing and the closure about an adjustment axis.

### TECHNICAL FIELD

This disclosure relates to a valve actuation mechanisms, and more particularly to a valve drive and associated process valve, such as a diaphragm valve.

### BACKGROUND

Valve drives are used in a variety of industrial process valves to actuate valve components such as diaphragms or plugs for controlling fluid flow. Conventional valve drives often require complex fastening systems or special tools to secure or remove the drive components, making assembly, maintenance, or inspection time-consuming. In some cases, inadvertent disassembly or unauthorized tampering may also be possible due to insufficient locking integrity.

### SUMMARY

The present disclosure provides valve drives and process valves.

A first aspect of the description relates to a valve drive for a process valve, the valve drive comprising a drive housing with an opening, which leads into an interior of the drive housing, and a closure, which closes the opening of the drive housing, wherein, in a locked state of the drive housing and the closure, at least one latching hook of the closure is in engagement with at least one cutout of the drive housing, and wherein, for unlocking the drive housing and the closure, the at least one latching hook moves out of the cutout of the drive housing by means of a relative rotational movement between the drive housing and the closure about an adjustment axis of the valve drive.

The provided valve drive increases installation safety with reduced effort. Accidental opening is prevented through the required rotational movement.

In addition, inspection, reparability and recyclability of the valve drive are improved since the closure can be easily transferred to the unlocked state. After simply removing the closure, the components can be removed from the interior of the valve drive and replaced if necessary. This improves the environmental impact of the valve drive.

According to one aspect of the present disclosure, at least one seal designed as a projection protrudes from the closure, wherein the at least one seal is destroyed at least in portions by at least one seal breaker of the drive housing during the relative rotational movement between the drive housing and closure for unlocking.

This makes it easy to see whether the valve drive has already been opened before it arrives for the scheduled inspection. Advantageously, this makes it easier to understand warranty cases.

According to one aspect of the present disclosure, the at least one seal engages in a recess of the drive housing in the locked state, wherein the at least one seal breaker is a wall of the recess.

This advantageously provides a structurally simple way of providing a sealing function.

According to one aspect of the present disclosure, for locking the drive housing and the closure, a relative axial movement, in particular parallel to the adjustment axis of the valve drive, takes place between the drive housing and the closure.

With the axial movement, the components arranged within the interior can be easily secured captively in their functional position using the closure.

According to one aspect of the present disclosure, a head of the at least one latching hook is guided over an associated insertion surface of the valve housing for locking and is initially pressed in the direction of an adjustment axis of the valve drive in order then to move into and engage in the at least one cutout when the at least one cutout is reached.

By engaging the head in the cutout, a locking configuration is established in which axial displacement of the closure relative to the drive housing is prevented. This means that the head of the latching hook can be removed from the cutout without causing any damage simply by rotating it.

Advantageously, the at least one resilient latching hook, after being pressed inward, can be pressed into the cutout by its own spring force in order to reach the locking position.

According to one aspect of the present disclosure, for unlocking, at least one unlocking surface of the at least one latching hook and an associated counter-surface of the at least one cutout cooperate during the relative rotational movement in order to guide the at least one latching hook out of the associated cutout onto a surrounding surface of the valve housing, which surrounding surface delimits the associated cutout.

The resilient latching hook is thus moved out of the cutout without being damaged, whereby the latching hook loses its latching effect and the closure can be removed from the drive housing.

According to one aspect of the present disclosure, after the relative rotational movement of the drive housing and the closure to each other, the at least one latching hook can be moved away from each other by means of a relative axial movement of the drive housing and the closure.

The removal of the latching hooks from the cutout by the radial movement allows the subsequent pulling movement of the closure from the drive housing.

According to one aspect of the present disclosure, during the relative axial movement of the drive housing and the closure, the at least one latching hook can be moved from the surrounding surface, which delimits the cutout, out of the interior of the drive housing via contacting a pull-off surface. This makes it easy to remove the closure.

According to one aspect of the present disclosure, the closure comprises at least one through-opening, through which a drive rod of the valve drive passes.

Advantageously, the closure is thus arranged at the valve-body-side opening of the drive housing, which advantageously results in degrees of design freedom on the side facing away from the valve body.

According to one aspect of the present disclosure, the valve drive comprises a pneumatic piston, which is movable along the adjustment axis and firmly connected to the drive rod, and a compression spring, which is supported on the pneumatic piston and on the drive housing.

According to one aspect of the present disclosure, the valve drive comprises a pneumatic piston, which is movable along the adjustment axis and firmly connected to the drive rod, and a compression spring, which is supported on the pneumatic piston and on the closure.

According to one aspect of the present disclosure, the closure comprises a clamping portion in order to clamp a lateral outer collar of a valve diaphragm between the clamping portion and a valve body.

According to one aspect of the present disclosure, in a locked state of the drive housing and the closure, a plurality of latching hooks of the closure are each in engagement with an associated one of a plurality of cutouts of the drive housing, wherein, for the unlocking of the drive housing and the closure, the plurality of latching hooks move out of the associated ones of the plurality of cutouts of the drive housing by means of a relative rotational movement between the drive housing and the closure.

A second aspect of the description relates to a process valve, in particular a diaphragm valve, comprising the valve drive according to the first aspect and a valve body rigidly connected to the valve drive.

According to one aspect of the present disclosure, a valve diaphragm with its lateral outer collar is clamped between the valve drive and the valve body, wherein, for its movement, the valve diaphragm is connected to the drive rod.

### BRIEF DESCRIPTION OF THE DRAWINGS

Further advantages and aspects of this disclosure emerge from the claims and from the following description of preferred exemplary embodiments of this disclosure, which are explained below with reference to the figures. Identical and functionally corresponding elements are provided with identical reference signs. In the drawings:

FIG. 1 shows a process valve in a section along an adjustment axis;

FIG. 2 shows the process valve in a detail;

FIG. 3 shows the process valve in a section perpendicular to the adjustment axis; and

FIG. 4 shows a closure of the valve drive.

### DETAILED DESCRIPTION

Valve drives for process valves often require tools or threaded fasteners to secure closures, complicating assembly, disassembly, and maintenance procedures. These systems may also lack tamper-evident features, making it difficult to detect unauthorized access. The present disclosure provides a valve drive that addresses these challenges by enabling secure, tool-free locking through resilient latching hooks and a rotational unlocking mechanism. In addition, a seal and seal-breaking feature visibly indicate prior access, improving serviceability and traceability while reducing the risk of unintentional disassembly.

Unless otherwise indicated, all terms used in this disclosure are intended to have their ordinary and customary meaning as understood by a person of ordinary skill in the art. The following definitions are provided to clarify the meaning of certain terms as used herein and are not intended to limit the scope of the disclosure or the appended claims. In the event of a conflict between a definition provided herein and the ordinary meaning of a term, the definition provided herein shall control.

As used herein, the term “closure” refers to a structural component configured to close the opening of the drive housing and to retain internal components in an assembled state.

As used herein, the term “latching hook” refers to a resilient structural element extending from the closure and configured to engage with a cutout of the drive housing to prevent axial separation, and to disengage therefrom via relative rotation.

As used herein, the term “seal breaker” refers to a portion of the drive housing that structurally interacts with a seal projection on the closure during relative rotation, thereby at least partially destroying the seal to indicate prior access or tampering.

As used herein, the term “adjustment axis” refers to the longitudinal axis along which the drive rod and pneumatic piston are moveable during valve actuation.

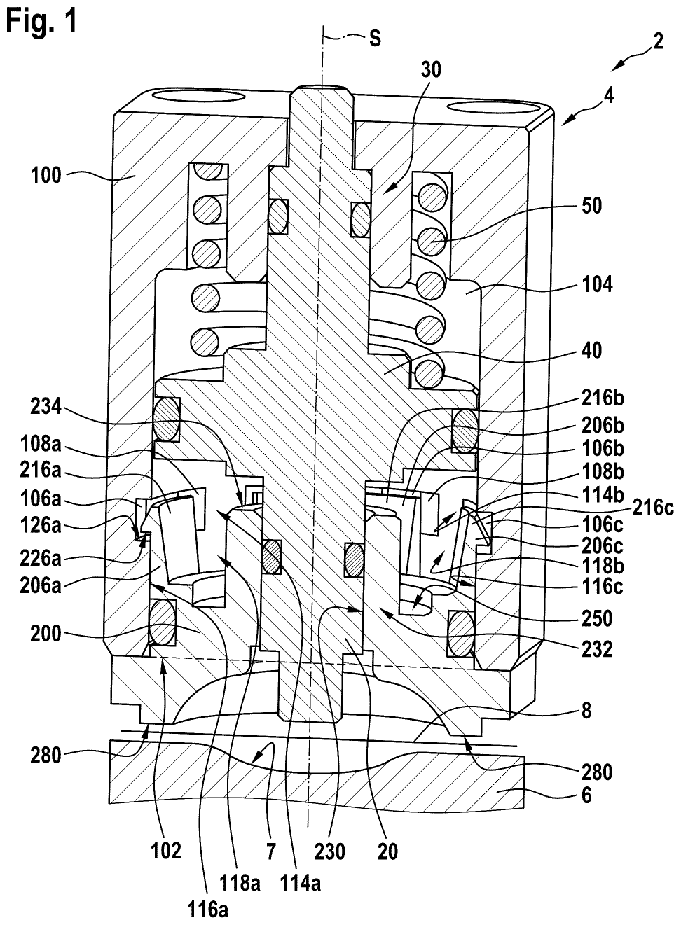

FIG. 1 shows a valve drive 4 for a process valve 2. The valve drive 4 comprises a drive housing 100 with an opening 102, which leads into an interior 104 of the drive housing 100, and a closure 200, which closes the opening 102 of the drive housing 100.

In a locked state of the drive housing 100 and the closure 200, at least one latching hook 206a-d of the closure 200 is in engagement with at least one cutout 106a-d of the drive housing 100.

For locking the drive housing 100 and the closure 200 during production, a relative axial movement, in particular parallel to an adjustment axis S of the valve drive 4, takes place between the drive housing 100 and the closure 200.

A head 216a-d of the at least one latching hook 206a-d is guided over an associated insertion surface 116a-d in the interior 104 of the drive housing 100 for locking and is initially pressed, i.e., upon insertion into the interior 104, in the direction of the adjustment axis S of the valve drive 4. Upon subsequent reaching of the at least one cutout 106a-d, the head 216a-d moves into the at least one cutout 106a-d due to the spring force of the associated latching hook 206a-d and thus engages in the at least one associated cutout 106a-d.

The insertion surface 116a-d of the output housing 100 is contacted by the at least one latching hook 206a-d when the closure 200 is inserted. In this case, the head 216a-d of the latching hook 206a-d is pressed further in the direction of the adjustment axis S as the closure 200 is further guided into the opening leading to the interior 104. In the state pressed inward, the latching hook 206a-d is guided further into the interior 104. The relevant head 216a-d snaps into the associated cutout 106a-d when it reaches it.

In the locked state, a locking surface 226a-d of the at least one latching hook 206a-d together with a counter-locking surface 126a-d of the associated cutout 106a-d prevents the closure 200 from being removed from the drive housing 100 by means of an axial movement.

The locking surface 226a-d and the counter-locking surface 126a-d run perpendicular to the adjustment axis S.

The valve drive 4 is delivered in the locked state.

For inspecting the valve drive 4, it is transferred to the unlocked state and the closure 200 is removed from the drive housing 100.

For the unlocking of the drive housing 100 and the closure 200, the at least one latching hook 206a-d can be moved out of the cutout 106a-d of the drive housing 100 by means of a relative rotational movement between the drive housing 100 and the closure 200 about the adjustment axis S.

During operation of the process valve 2, the relative rotational movement is prevented by fastening means (not shown), in particular bolts or screws, passing through both the drive housing 100 and the closure 200 in order to fasten the valve drive 4 to a valve body 6. The drive housing 100 and the closure 200 cannot therefore be rotated relative to each other during operation.

During the relative axial movement of the drive housing 100 and the closure 200, for removing the closure 200, the at least one latching hook 206a-d can be moved from the surrounding surface 114a-d, which delimits the cutout 106a-d, out of the interior 104 of the drive housing 100 via contacting a pull-off surface 118a-d.

The closure 200 comprises at least one through-opening 230, through which a drive rod 20 of the valve drive 4 passes.

The drive housing 100 comprises at least a first guide portion 30 for axially guiding the drive rod 20 of the valve drive 4, wherein the closure 200 comprises at least a second guide portion 232 for axially guiding the drive rod 20 of the valve drive 4. The closure also serves to guide the drive rod 20 during operation.

The drive rod 20 can be moved along the adjustment axis S during operation of the process valve 2.

The closure 200 is positively received in the drive housing 100 in at least one notional perpendicular plane of the adjustment axis S. This is ensured, for example, by the outer surfaces of the latching hooks 206a-c, which, in the locked state, rest against the associated surfaces 116a-d.

FIG. 1 shows the valve drive 4 for a normally closed process valve. The valve drive 4 comprises a pneumatic piston 40, which is movable along the adjustment axis S and firmly connected to the drive rod 20, and a compression spring 50, which is supported on the pneumatic piston 40 and on the drive housing 100.

For example, in a normally open process valve, the valve drive 4 comprises a pneumatic piston, which is movable along the adjustment axis S and firmly connected to the drive rod, and a compression spring, which is supported on the pneumatic piston and on the closure 200.

A circular receiving groove 250 of the closure 200 is provided so that the compression spring of the valve drive 4 engages in the receiving groove 250.

A stop 234 of the closure 200 arranged in the interior 104 provides a stop surface so that the components arranged in the interior 104, possibly subjected to a spring force along the adjustment axis S, can rest against the closure 200.

The closure 200 is secured to the drive housing 100 along the adjustment axis S via the at least one latching hook 206a-d in a pull-out-proof manner. The closure 200 thus holds the components arranged in the interior 104.

In the example shown, it is provided that the closure 200 comprises a clamping portion 280 in order to clamp a lateral outer collar of a valve diaphragm 8 between the clamping portion 280 and a valve body 6.

In a locked state of the drive housing 100 and the closure 200, a plurality of latching hooks 206a-d of the closure 200 are each in engagement with an associated one of a plurality of cutouts 106a-d of the drive housing 100, wherein, for the unlocking of the drive housing 100 and the closure 200, the plurality of latching hooks 206a-d move out of the associated ones of the plurality of cutouts 106a-d of the drive housing 100 by means of a relative rotational movement between the drive housing 100 and the closure 200.

In the example shown, two of four latching hooks 206a-d are positioned opposite each other in pairs. Two of four cutouts 106a-d are located opposite each other in pairs.

The process valve 2 is designed, for example, as a diaphragm valve. Of course, other types of process valves such as seat valves may also be used.

The process valve 2 comprises the valve drive 4 and the valve body 6 rigidly connected to the valve drive 4.

In the example of the diaphragm valve, a valve diaphragm 8 with its lateral outer collar is clamped between the valve drive 4 and the valve body 6, wherein, for its movement, the valve diaphragm 8 is connected to the drive rod 20.

For closing a flow channel of the process valve 2, the valve diaphragm 8 is pressed onto a valve seat 7 of the valve body 6 via the drive rod 8 and a pressure piece (not shown). In order to open the flow channel, the valve diaphragm 8 is lifted from the valve seat 7 by means of the drive rod 20.

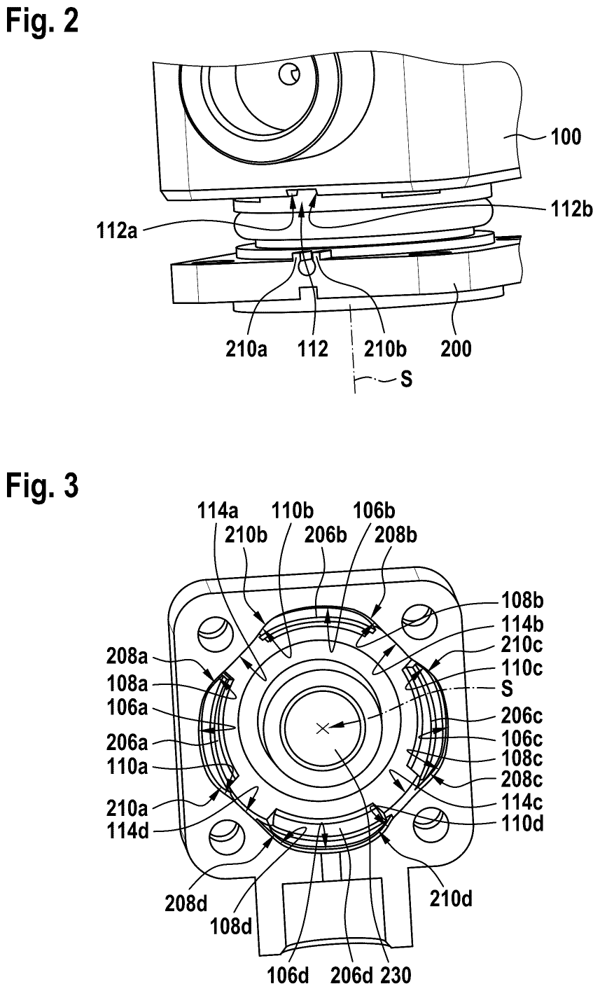

FIG. 2 shows a detail of the valve drive 4 in a not yet locked state. At least one seal 210a-b formed as a projection protrudes from the closure 200. The at least one seal 210a-b is destroyed at least in portions by at least one seal breaker 112a-b of the drive housing 100 during the relative rotational movement between the drive housing 100 and closure 200 for unlocking.

In the example, the at least one seal 210a-b protrudes from the closure 200 in parallel with the adjustment axis S.

In the locked state, the at least one seal 210a-b engages in a recess 112 of the drive housing 100. The at least one seal breaker 112a-b is a wall of the recess 112.

In order to remove the closure 200 from the drive housing 100 after locking, it is necessary to rotate the two components against each other. As a result, at least one seal 210a-b located in the recess 112 is destroyed.

The recess 112 adjoins the outer surface of the drive housing 100, as a result of which both a broken seal and an intact seal 210a-b are visible from the outside.

After the relative rotational movement of the drive housing 100 and the closure 200 to each other, the at least one latching hook 206a-d is removed by means of a relative axial movement of the drive housing 100 and the closure 200 away from each other.

FIG. 3 shows the valve drive 4 in a section perpendicular to the adjustment axis in a locked state. Here, the latching hooks 206a-d are in engagement with the associated cutouts 106a-d.

It is provided that, for unlocking, at least one unlocking surface 208a-d, 210a-d of the head 216a-d of the at least one latching hook 206a-d and an associated counter surface 108a-d, 110a-d of the at least one cutout 106a-d cooperate during the relative rotational movement so as to guide the at least one latching hook 206a-d out of the associated cutout 106a-d onto a surrounding surface 114a-d of the drive housing 100, which surrounding surface delimits the associated cutout 106a-d.

The at least one unlocking surface 208a-d, 210a-d of the head 216a-d extends in a manner deviating from a notional circle in the circumferential direction with its center on the adjustment axis S.

A shape and arrangement of the at least one unlocking surface 208a-d, 210a-d, a shape and arrangement of the associated at least one counter surface 108a-d, 110a-d and the restoring force of the latching hook 206a-d significantly determine the force that must be exceeded in order to move the at least one latching hook 206a-d out of the cutout 106a-d by means of the relative rotational movement. With a plurality of latching hooks 206a-d, a correspondingly combined force results.

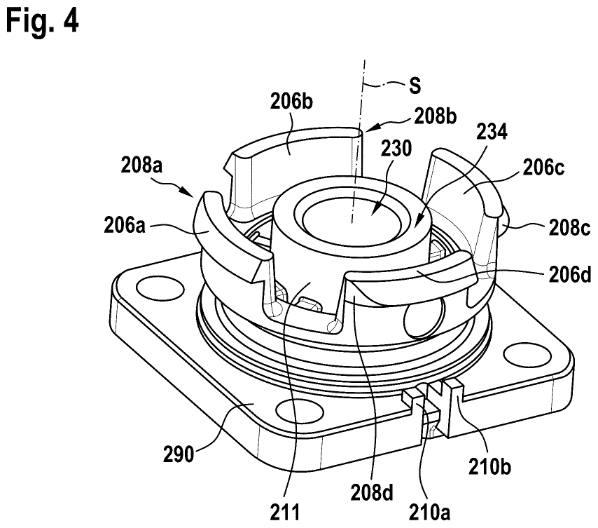

FIG. 4 shows an example of the closure 200 in a perspective view with the scal 210a-b unbroken. The closure 200 has a flange region 290 with a hole pattern. The at least one seal 210a-b protrudes from the flange region 290.

The latching hooks 206a-d follow a notional circle with its center on the adjustment axis S.

Located within the latching hooks 206a-d is a sleeve 211, which provides at least part of the through-opening 230. Unless otherwise expressly indicated, the following terms have the meanings provided below. These definitions are intended to clarify, not limit, the scope of the claims.

The disclosed valve drive offers several advantages over conventional designs. The use of resilient latching hooks and a rotational unlocking mechanism provides secure retention and tool-free disassembly. The integrated seal and seal-breaker system enables tamper detection, improving traceability and warranty enforcement. The closure is easily removable for inspection and service, enhancing reparability and recyclability. These features collectively reduce assembly time, improve safety, and support sustainable product design.

To the extent not already described, the different features and structures of the various embodiments can be used in combination, or in substitution with each other as desired. That one feature is not illustrated in all of the embodiments is not meant to be construed that it cannot be so illustrated, but is done for brevity of description. Thus, the various features of the different embodiments can be mixed and matched as desired to form new embodiments, whether or not the new embodiments are expressly described. All combinations or permutations of features described herein are covered by this disclosure.

Persons skilled in the art will understand that the structures and methods specifically described herein and shown in the accompanying figures are non-limiting exemplary aspects, and that the description, disclosure, and figures should be construed merely as exemplary of aspects. It is to be understood, therefore, that the present disclosure is not limited to the precise aspects described, and that various other changes and modifications can be effected by one skilled in the art without departing from the scope or spirit of the disclosure.

Additionally, the elements and features shown or described in connection with certain aspects can be combined with the elements and features of certain other aspects without departing from the scope of the present disclosure, and that such modifications and variations are also included within the scope of the present disclosure. Accordingly, the subject matter of the present disclosure is not limited by what has been particularly shown and described.

What is claimed:

1. A valve drive for a process valve, comprising:
a drive housing having a valve-body-side opening that leads into an interior of the drive housing; and
a closure configured to close the valve-body-side opening of the drive housing;
wherein, in a locked state of the drive housing and the closure, at least one latching hook of the closure engages at least one cutout of the drive housing; and
wherein, to unlock the drive housing and the closure, the at least one latching hook is configured to move out of the cutout by a relative rotational movement between the drive housing and the closure about an adjustment axis of the valve drive.

2. The valve drive of claim 1, further comprising at least one seal formed as a projection that extends from the closure,
wherein the at least one seal is at least partially destroyed by at least one seal breaker of the drive housing during the relative rotational movement for unlocking.

3. The valve drive of claim 2, wherein the at least one seal engages a recess of the drive housing in the locked state,
and the at least one seal breaker comprises a wall of the recess.

4. The valve drive of claim 1, wherein locking the drive housing and the closure includes a relative axial movement between the drive housing and the closure,
the axial movement being parallel to the adjustment axis of the valve drive.

5. The valve drive of claim 4, wherein a head of the at least one latching hook is guided over an insertion surface of the drive housing during locking,
and the head is pressed in the direction of the adjustment axis to engage the cutout.

6. The valve drive of claim 5, wherein during unlocking, an unlocking surface of the at least one latching hook cooperates with a counter surface of the cutout
to guide the latching hook out of the cutout onto a surrounding surface of the drive housing.

7. The valve drive of claim 6, wherein after the relative rotational movement, the at least one latching hook is moved away from the cutout
by a relative axial movement between the drive housing and the closure.

8. The valve drive of claim 7, wherein during the relative axial movement, the at least one latching hook is moved from the surrounding surface
out of the interior of the drive housing by contacting a pull-off surface.

9. The valve drive of claim 1, wherein the closure comprises at least one through-opening through which a drive rod of the valve drive extends.

10. The valve drive of claim 9, further comprising a pneumatic piston connected to the drive rod and movable along the adjustment axis,
and a compression spring supported between the pneumatic piston and the drive housing.

11. The valve drive of claim 9, further comprising a pneumatic piston connected to the drive rod and movable along the adjustment axis,
and a compression spring supported between the pneumatic piston and the closure.

12. The valve drive of claim 1, wherein the closure comprises a clamping portion configured to clamp a lateral outer collar of a valve diaphragm
between the clamping portion and a valve body.

13. The valve drive of claim 1, wherein in the locked state, a plurality of latching hooks of the closure each engage an associated one of a plurality of cutouts of the drive housing,
and to unlock the drive housing and the closure, the plurality of latching hooks are configured to move out of the cutouts
by a relative rotational movement between the drive housing and the closure.

14. A process valve comprising:
the valve drive of claim 1; and
a valve body rigidly connected to the valve drive.

15. The process valve of claim 14, further comprising a valve diaphragm having a lateral outer collar clamped between the valve drive and the valve body,
and the valve diaphragm being connected to the drive rod for movement.
